(19) United States
(12) Patent Application Publication
(10) Pub. No.: US 2001/0042035 A1
(43) Pub. Date: Nov. 15, 2001

(54) System and method for an asset reallocation calculator

(76) Inventors: Keith Kelly, Fairfax, VA (US); Joseph Kelly, Fairfax, VA (US)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 09/725,003

(22) Filed: Nov. 29, 2000

Related U.S. Application Data
(60) Provisional application No. 60/167,679, filed on Nov. 29, 1999.

(51) Int. Cl. G06F 17/60

(52) U.S. Cl. 705/36

(57) ABSTRACT

A method and system (known as “A.R.C.”) to determine, on behalf of a mortgagee, how to allocate assets by using a closing cost credit when initiating or refinancing a mortgage associated with a property (e.g., a home, a business, or a vehicle, including a boat). The method and system take into account the tax savings, future value of money, and the effect of paying down debt for a mortgagee.

### CROSS-REFERENCE TO CO-PENDING APPLICATIONS

The present application is related to co-pending application Ser. No. 60/156,713, filed Sep. 30, 1999; application Ser. No. 60/162,154, filed Oct. 29, 1999; application Ser. No. 60/167,679, filed Nov. 29, 1999; application Ser. No. 09/453,231, filed Dec. 3, 1999; and International application number PCT/US00/27074, filed Oct. 2, 2000, naming Keith Kelly and Joseph Kelly as co-inventors. The contents of those applications are incorporated herein by reference.

### BACKGROUND OF THE INVENTION

1. Field of the Invention

The present invention is directed to a method and system for determining cost/benefit trade-offs as part of a mortgage transaction, and more specifically to an Asset Reallocation Calculator (hereinafter and “A.R.C.”) for determining whether a (potential) homeowner should pay points and closing costs during purchase or refinance.

2. Discussion of the Background

During a typical creation of a mortgage and/or the refinance of a mortgage, a mortgagee must cover costs corresponding to loan initiation fees and the mortgage closing. When refinancing a mortgage, the mortgagee has the choice of paying those costs out-of-pocket at closing or rolling those costs back into the mortgage, either in the form of a higher principal amount or a higher interest rate. In the case of a higher principal amount, the mortgagee pays interest on those costs during at least a portion of the loan. In the case of the higher interest rate, the mortgagee pays more per month on the whole remaining balance of the mortgage.

The choice between paying the costs out-of-pocket and rolling the costs back into the mortgage can be difficult to make. The choice is complicated by a myriad of factors (e.g., prevailing interest rates, whether other higher interest debt exists, and the current rate of return on other investments). Since many mortgagees cannot properly assess how those factors affect the overall choice, the mortgagees often rely on the advice of the mortgagor or mortgage broker who may have a bias or motivation different than that of the mortgagee.

### SUMMARY OF THE INVENTION

It is an object of the present invention to provide an objective analysis of the trade-offs between what interest rates and costs to choose when initiating or refinancing a mortgage.

It is another object of the present invention to facilitate investment of money not rolled into a mortgage transaction into another good or service.

These and other objects of the present invention are achieved through an Asset Reallocation Calculator (hereinafter “ARC”) that provides feedback for applying assets towards long term savings, reducing debt, or a combination of both. The calculation takes into consideration various long-term factors (e.g., tax savings and time value of money).

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a schematic illustration of a computer system for analyzing the trade-offs between what interest rates and costs to choose when initiating or refinancing a mortgage;

FIGS. 2A to 2C are a flowchart showing the process of analyzing the trade-offs when initiating a mortgage;

FIG. 3 is a screen capture showing an exemplary mortgage being initiated;

FIG. 4 is a screen capture of the results of the mortgage of FIG. 3;

FIGS. 5A and 5B are a flowchart showing the process of analyzing the trade-offs when refinancing a mortgage;

FIG. 6 is a screen capture showing an exemplary mortgage being refinanced; and

FIG. 7 is a screen capture of the results of the refinance query of FIG. 6.

### DETAILED DESCRIPTION OF THE PREFERRED EMBODIMENTS

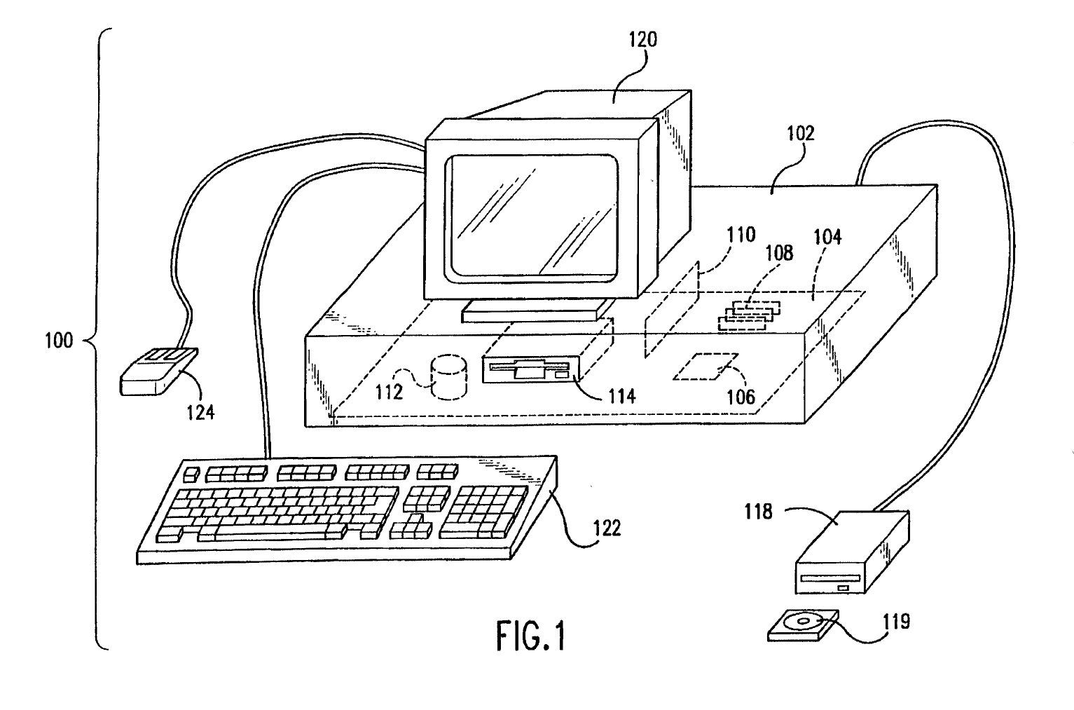

Referring now to the drawings, wherein like reference numerals designate identical or corresponding parts throughout the several views, FIG. 1 is a schematic illustration of a computer system for analyzing the trade-offs between what interest rates and costs to choose when initiating or refinancing a mortgage. A computer 100 implements the method of the present invention, wherein the computer housing 102 houses a motherboard 104 which contains a CPU 106, memory 108 (e.g., DRAM, ROM, EPROM, EEPROM, SRAM, SDRAM, and Flash RAM), and other optional special purpose logic devices (e.g., ASICs) or configurable logic devices (e.g., GAL and reprogrammable FPGA). The computer 100 also includes plural input devices, (e.g., a keyboard 122 and mouse 124), and a display card 110 for controlling monitor 120. In addition, the computer system 100 further includes a floppy disk drive 114; other removable media devices (e.g., compact disc 119, tape, and removable magneto-optical media (not shown)); and a hard disk 112, or other fixed, high density media drives, connected using an appropriate device bus (e.g., a SCSI bus, an Enhanced IDE bus, or a Ultra DMA bus). Also connected to the same device bus or another device bus, the computer 100 may additionally include a compact disc reader 118, a compact disc reader/writer unit (not shown) or a compact disc jukebox (not shown). Although compact disc 119 is shown in a CD caddy, the compact disc 119 can be inserted directly into CD-ROM drives which do not require caddies. In addition, a printer (not shown) also provides printed analyses of the trade-offs between what interest rates and costs to choose when initiating or refinancing a mortgage.

As stated above, the system includes at least one computer readable medium. Examples of computer readable media are compact discs 119, hard disks 112, floppy disks, tape, magneto-optical disks, PROMs (EPROM, EEPROM, Flash EPROM), DRAM, SRAM, SDRAM, etc. Stored on any one or on a combination of computer readable media, the present invention includes software for controlling both the hardware of the computer 100 and for enabling the computer 100 to interact with a human user. Such software may include, but is not limited to, device drivers, operating systems and user applications, such as development tools. Such computer readable media further includes the computer program product of the present invention for analyzing the trade-offs between what interest rates and costs to choose when initiating or refinancing a mortgage. The computer code devices of the present invention can be any interpreted or executable code mechanism, including but not limited to scripts (including Javascript), interpreters, Active X controls, dynamic link libraries, Java classes, and complete executable programs.

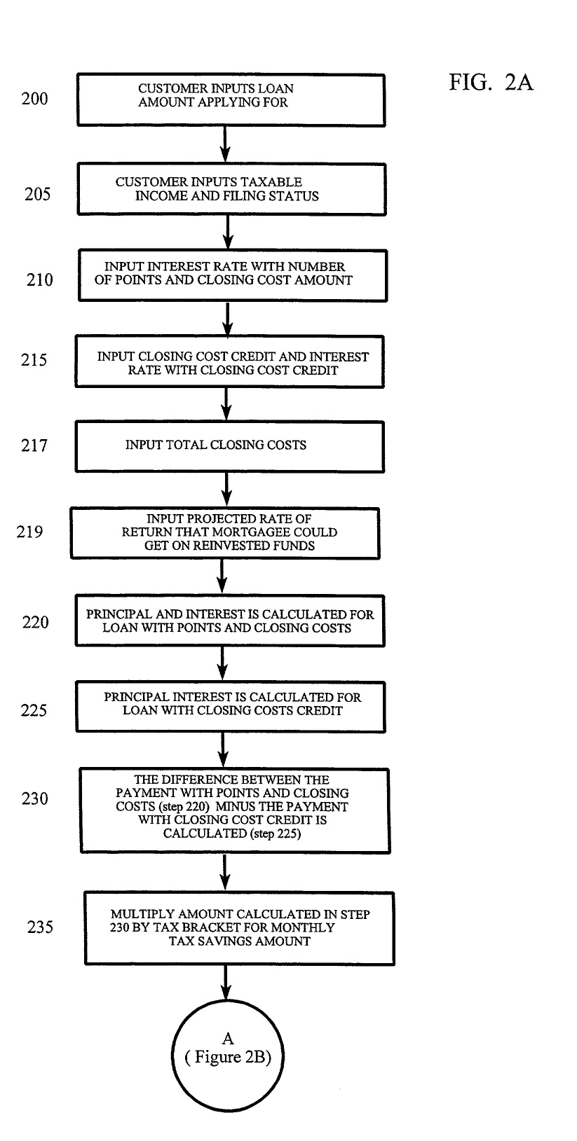

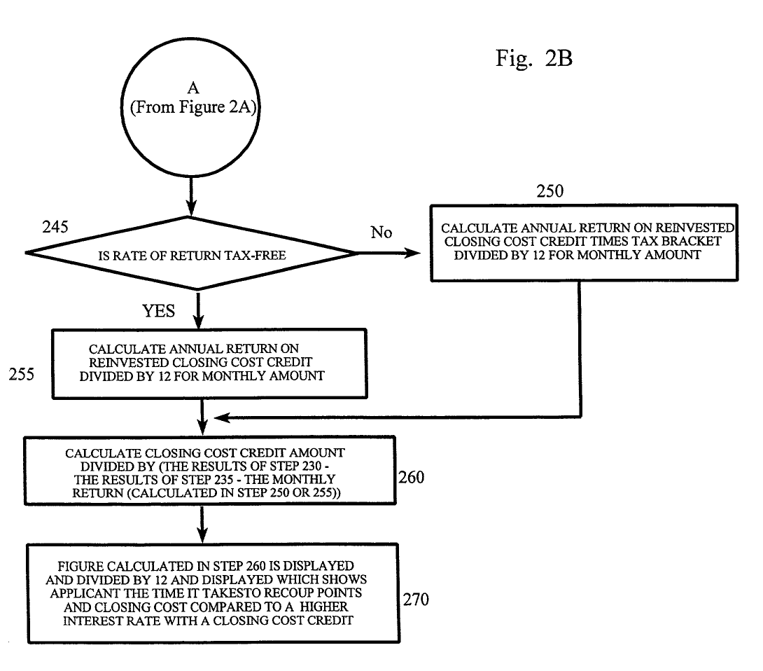

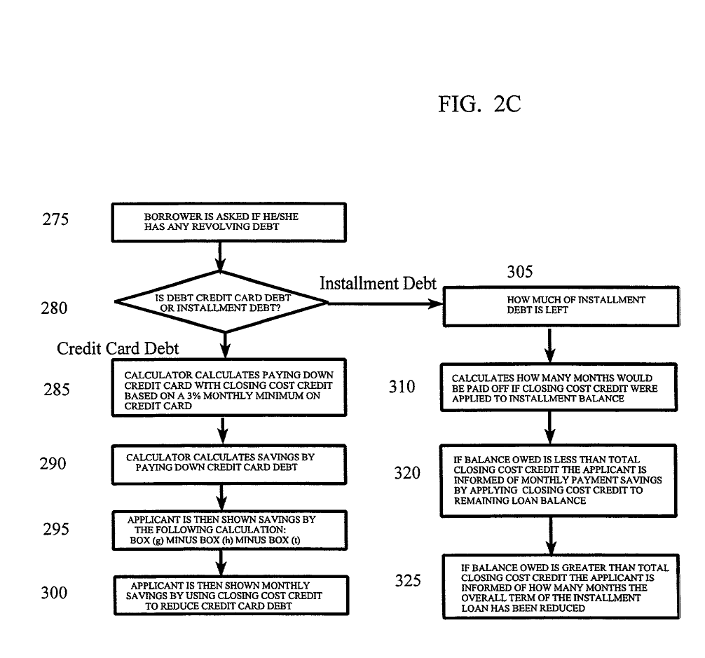

As shown in FIG. 2, the method ad system of the present invention receive a series of inputs from the mortgagee and calculate a series of tax savings and investment return results as illustratively shown in the flowchart. As would be appreciated by one of ordinary skill in the art, the order of the data collection and calculation steps is arbitrary and may be reordered as long the data for any one of the calculations is collected before that calculation needs to occur. In steps 200, 205, 210, 215, 217 and 219, respectively, the customer inputs (1) the loan amount being financed, (2) the customer's taxable annual income and filing status, (3) the interest rate with paying points and closing costs, (4) the interest rate where the lender is providing a closing cost credit and the closing cost credit amount being given by the lender, (5) the total closing costs to finance the purchase with points and closing costs, and (6) the investment return that the investor feels can be achieved (and whether or not that investment is tax-free). If customer does not know closing cost amount an estimate of closing costs will be provided.

Having input those six parameters, the method and system of the present invention calculate the following:

in step 220, the principal and interest for the interest rate which has points and closing costs;

in step 225, the principal and interest for the interest rate which has a closing costs credit;

in step 230, the monthly difference between paying points and closing costs (calculated instep 220) versus a higher interest rate with a credit towards closing costs (calculated in step 225);

in step 235, the tax savings of the result of step 230 (by using the mortgagee's inputted taxable income and filing status).

As shown in FIG. 2B, the process of FIG. 2A is continued in step 245. In step 245, the system transfers control to step 250 or 255 depending on whether the rate of return was taxable or tax-free, respectively. If step 245 determines that the rate of return was taxable, in step 250, monthly return is calculated as the annual return on the closing cost credit amount times the tax bracket divided by 12 months. If step 245 determines that the rate of return was tax-free, in step 255, monthly return is calculated as the annual return on the closing cost credit amount divided by 12 months. After either of steps 250 and 255, the process continues with step 260. In step 260, a first ratio, corresponding to the number of months required to recoup the costs, is calculated. The numerator of the first ratio is the closing cost credit amount. The denominator of the first ratio is:

(the results of step 230−the results of step 235−the monthly return), where the monthly return is calculated in either step 250 or 255 depending on the tax treatment of the rate of return.

In step 270, the method and system display (or print) at least one of (1) the number of months required to recoup the costs (corresponding to the first ratio calculated in step 260), or the number of years required to recoup the costs. In the latter case, the number of years is calculated by dividing the number of months (i.e., the first ratio) by 12.

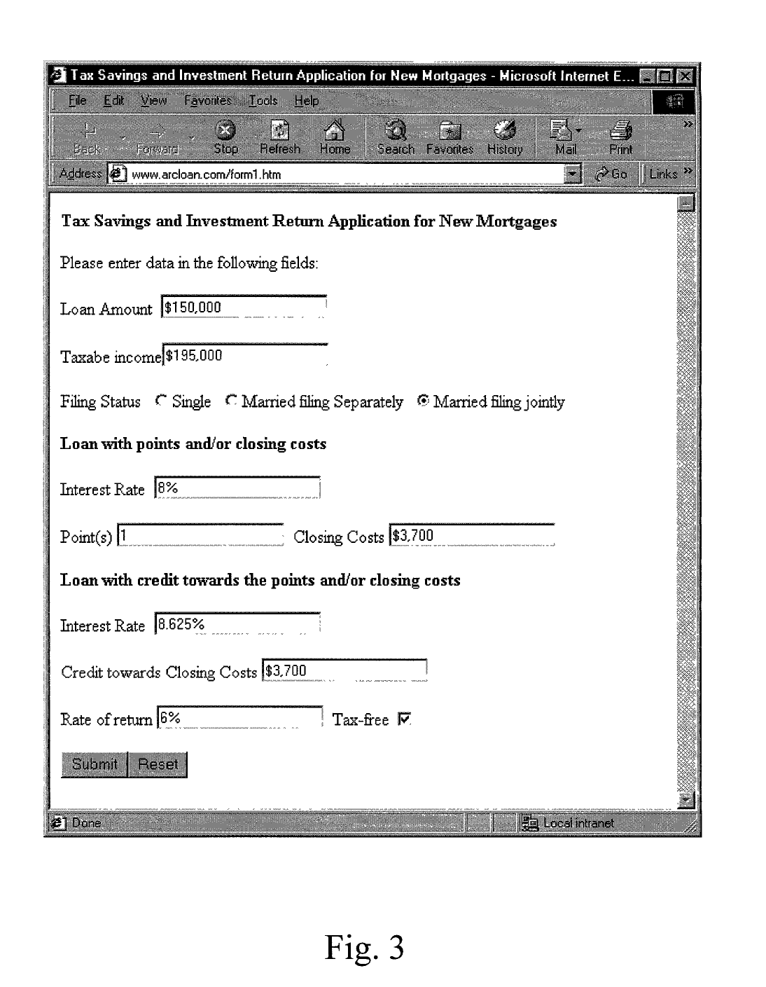

FIG. 3 shows an illustrative example of the information collected by the present invention. In the example, a mortgagee is securing a $150,000 loan. For that loan amount, the mortgagee can either get financing at (1) 8% with one point and closing cost (average total cost $3700) or (2) 8.625% with a credit towards the points and closing cost (average credit $3700). The mortgagee also has indicated an annual income of $195,000, a status of “married filing jointly,” and a tax-free rate of return of 6%.

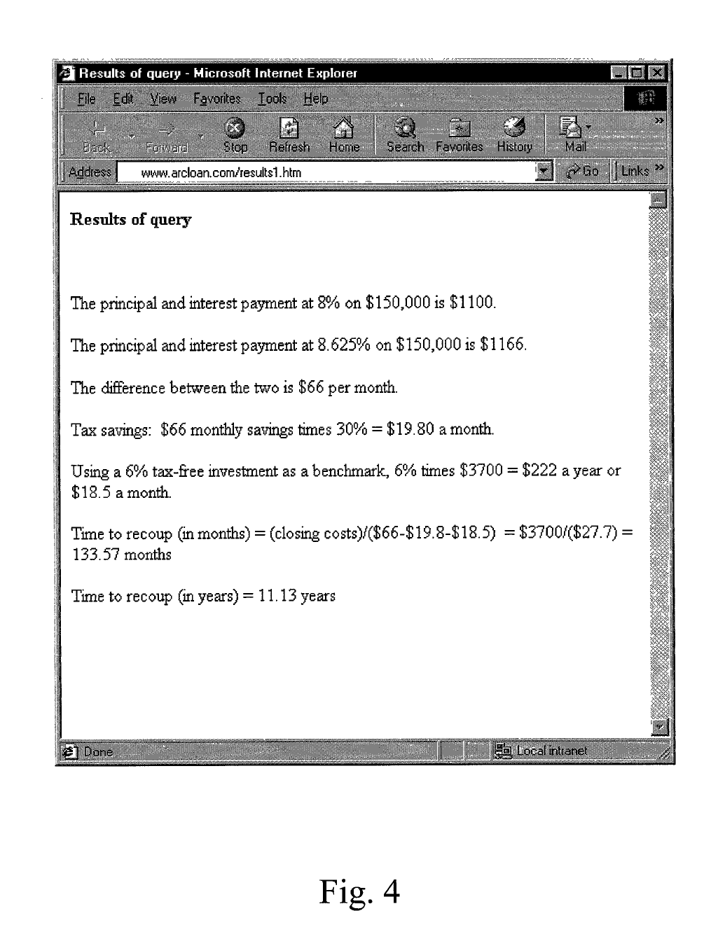

As shown in FIG. 4, the results of submitting the information of FIG. 3 is that the principal and interest payment at 8% on $150,000 is $1100; the principal and interest payment at 8.625% on $150,000 is $1166; and the difference between the two is $66 per month. Based on the tax bracket determined by the system (e.g., 30% tax bracket), the system then multiplies the $66 monthly savings by 30%. The result is that the tax savings realized by going at a higher interest rate is $19.80 a month. Using the 6% tax-free investment of FIG. 3, the system calculates how much the mortgagee would receive if the closing cost credit were invested at the specified return rate. Accordingly, if the investment would return 6% times $3700=$222 a year or $18.5 a month.

The system then calculates the amount of time it would take to recoup the points and closing cost paid by the mortgagee versus the credit paid by the lender towards the points and closing cost using the tax savings and future value of money calculations. That is, by spending $3,700 to buy down the interest rate, the mortgagee saves $66 per month, which recoups the costs in how long?

The system subtracts the tax savings and investment earnings from the $66 per month. ($66−$19.8−$18.5=$27.7) The system then takes this $27.70 amount and divides it back into the closings costs amount ($3700 divided by $27.70=133.57 months or 11.13 years). The system informs the mortgagee that it would take 11.13 years to recoup the points and closing costs if the mortgagee chose the lower interest rate. If the mortgagee chose an investment return without tax-free savings the system would have further calculated the tax payments on the investment returns.

Although the system can determine the tax savings (e.g., $19.80) if the mortgagee chooses the higher interest rate with the closing cost credit, what should the mortgagee do as a result. The mortgagee can either pay down other debt or invest the money in other goods or services.

Accordingly, as shown in FIG. 2C, the system asks if the mortgagee has any revolving debt. The system uses a fixed (e.g., 3%) monthly minimum payment for any revolving debt. For example, if the mortgagee has a credit card with a $5000 balance, the system will calculate the monthly savings if the credit card is paid down using the closing cost credit. Thus, $3700 paid down at a 3% minimum monthly payment=$111 a month. The system then will take the monthly savings incurred when the closing cost credit is applied to pay down a revolving debt and add this amount to the monthly tax savings realized by going at the higher interest rate. The system will take the sum of these two calculations and subtract the monthly difference between the payment that has the points and closing costs minus the payment that has a closing cost credit. In the example, there is $111 a month in credit card savings plus $19.8 tax savings minus the $66 more per month at 8.5%. This gives a savings of $111+$19.8−$66=$64.8 monthly. The system will then inform the mortgagee that the mortgagee will save $64.80 per month or $777 per year by going at the higher interest rate with the closing cost credit applied to reducing credit card debt.

In an alternate embodiment, the debt to be analyzed may not be credit card debt but rather other revolving debt (or monthly payment) that can be paid off using the closing cost credit. For example, if the mortgagee had $3000 left on a car loan with a $250 monthly payment, then the system shows that the mortgagee can save $250 a month for ($3000 divided by $250 a month=12 months) of the term left on the car loan. The system explains to the mortgagee that the mortgagee can reduce monthly debt by $250 a month for the next 12 months by paying off the car loan.

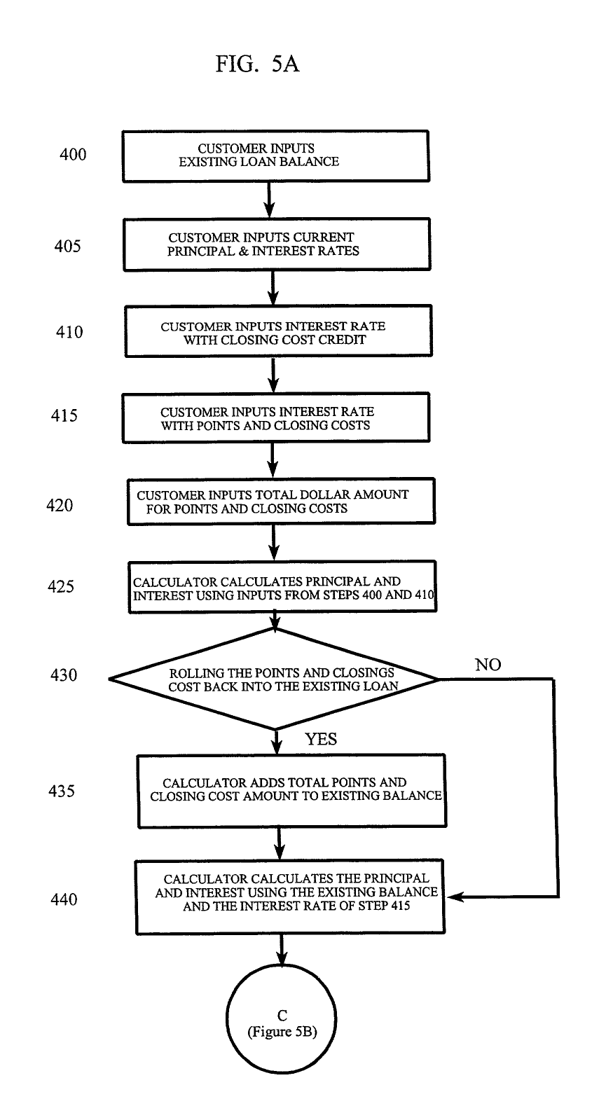

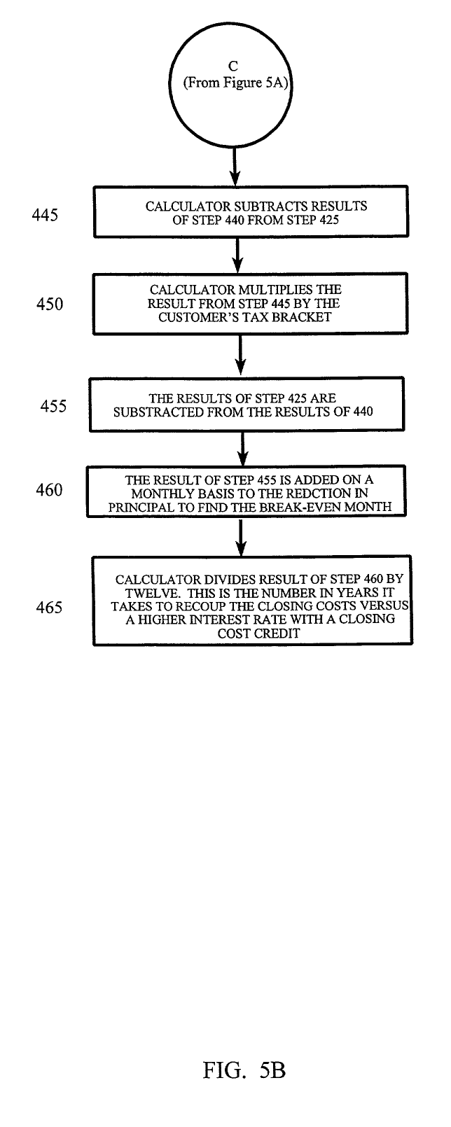

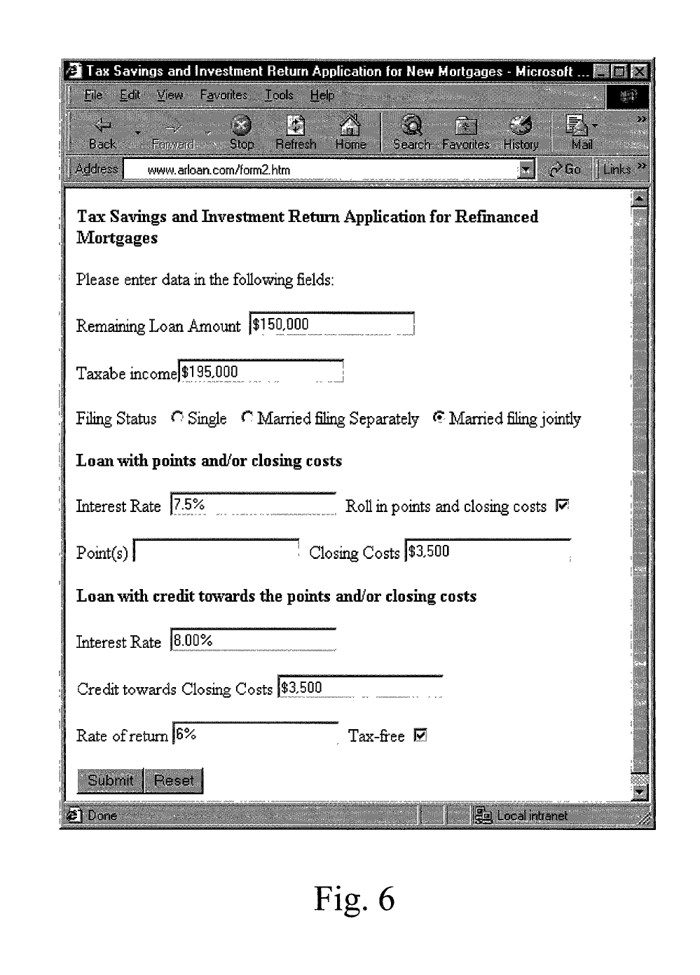

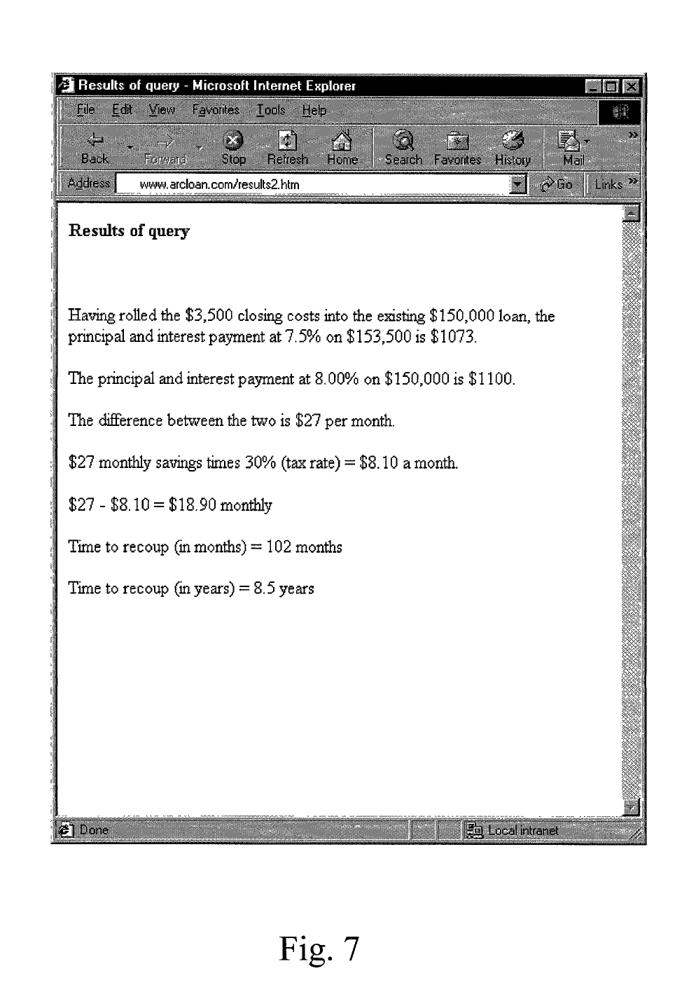

In an embodiemnt shown in FIGS. 5A and 5B, the present invention can perform for a refinance transaction a process similar to the process described above for a loan initiation. In that case, the mortgagee (e.g., of a house, boat or other property) is shown the time it takes to recoup paying points and closing costs versus a higher interest rate with a credit towards closing costs when refinancing a property. The present invention illustrates the tax savings gained by going at a higher interest rate with a closing cost credit. The system calculates principal and interest payments on a refinance transaction if the mortgagee wraps points and closing costs back into the existing balance.

As shown in steps 400, 405, 410, 415, and 420, respectively, the mortgagee inputs (1) the current amount of the mortgage to be refinanced, (2) the current principal and interest payment, (3) the refinance interest rate with closing cost credit, (4) the refinance interest rate with points and closing costs, and (5) the total dollar amount for points and closing costs. In step 425, the system calculates pincipal and interest payments using the information collected in steps 400 and 410. In step 430, the system determines if the mortgagee is rolling the points and closing costs back into the current mortgage balance.

If the system determines in step 430 that the mortgagee is rolling the points and closing costs back into the current mortgage balance, then control transfers to step 435. In step 435, the system adds points and closing costs to current loan balance to create a new current balance. If the system determines in step 430 that the mortgagee is not rolling the points and closing costs back into the current mortgage balance, then control transfers directly to step 440, thereby leaving the current balance unchanged. After either step 430 or 435, control is transferred to step 440. In step 440, the system calculates the refinance principal and interest using the current balance and the interest rate information from step 415. Control then passes to step 445 that calculates the difference between the results of steps 440 and 425. The result of step 445 is then multiplied by mortgagee's tax rate (either given by the mortgagee or calculated from the mortgagee's taxable income and filing status). In step 455, the result of step 425 is then subtracted from the result of step 440. In step 460, the system subtracts the monthly reduction in principal between the loan with the closing cost credit and the loan with the closing costs on a monthly basis. (As would be appreciated by one of ordinary skill, that difference increases on a month-by-month basis.) This result is added to the result of step 455 each month until it equals the closing cost credit amount. When these monthly additions equal the closing cost credit amount, that month is the break-even month in total months. Optionally, in step 465, the system may divide the number of months to recoup by 12 to give the number of years to recoup the closing costs.

An example of the differences between a refinancing with closing costs and a refinancing with a closing cost credit is shown below.

| Loan with closing cost | | Loan with a closing cost credit | |
|---|---|---|---|
| 7.5% | | 8.00% | |
| $3500 | closing cost | 0$ | closing costs, |
| | | $3,500 | closing cost credit |
| $150,000 | existing balance | $150,000 | loan balance |
| $153,500 | balance with closing | | |
| | cost wrapped back into loan | | |
| $1073 | principal & interest | $1100 | principal & interest |
| | | $27 | more per month |
| | | $27 | times 30% tax |
| | | | bracket = |
| | | | $8.10 tax savings |
| | | $27 | minus $8.10 = |
| | | | $18.90 |

The additional principal reduction for 7.5% interest rate vs 8% for the first month is $13.26. This is added to the $18.90. (The reduction for the second month is $13.30.) Accordingly, using the additive process described for step 460 above, the $3,500 closing cost is recouped in 102 months or 8.5 years. As would also be appreciated by one of ordinary skill, the closing costs and the closing cost credit, although the same in the example above, may in fact be different.

Obviously, numerous modifications and variations of the present invention are possible in light of the above teachings without departing from the intended scope of the present invention.

1. A computer program product, comprising:
a computer storage medium and a computer program code mechanism embedded in the computer storage medium for causing a computer to control the analysis of the trade-offs in a mortgage transaction, the computer program code mechanism comprising:
a first computer code device configured to determine a first interest rate corresponding to a mortgage with at least one of closing costs and points;
a second computer code device configured to determine a second interest rate, higher than the first interest rate, corresponding to a mortgage with a closing cost credit; and
a third computer code device configured to calculate a time to recoup the costs of the higher second interest rate by reinvesting the at least one of closing costs and points.

2. The computer program product as claimed in claim 1, wherein the third computer code device comprises a fourth computer code device configured to calculate an effect of paying off a secondary loan with a savings created by the reinvestment.

3. The computer program product as claimed in claim 1, wherein the third computer code device comprises a fourth computer code device configured to calculate an effect of paying off credit card debt with a savings created by the reinvestment.

4. The computer program product as claimed in claim 1, wherein the third computer code device comprises a fourth computer code device configured to calculate an effect of paying off a revolving debt with a savings created by the reinvestment.

5. The computer program product as claimed in claim 1, further comprising a networked interface for displaying at least one of goods and services that can be purchased with a savings created by the reinvestment.
